(19) United States
(12) Patent Application Publication
(10) Pub. No.: US 2019/0294774 A1
(43) Pub. Date: Sep. 26, 2019

(54) Passcode Authentication System and Method with Colored Light Feedback

(71) Applicant: Seung Pil Kim, Temecula, CA (US)

(72) Inventor: Seung Pil Kim, Temecula, CA (US)

(21) Appl. No.: 15/934,984

(22) Filed: Mar. 24, 2018

(51) Int. Cl. G06F 21/36

(52) U.S. Cl. CPC G06F 21/36

(57) ABSTRACT

A passcode authentication system and method are disclosed, wherein color display is used instead of alpha numeric displays. The passcode authentication system according to the current invention includes a LED color display unit to identify the code entered by a user. This provides a feedback to indicate a code selected. A single or plurality of buttons are used to select a sequence of colors, wherein the sequence of colors is converted to a sequence of digital codes. An example of color code set is; Red, Green, Blue, Cyan, Magenta, Yellow, and White, but the color code size can be changed by removing or adding additional unique colors as necessary. A user can memorize the passcode as a sequence of colors as well as numbers utilizing a simple mapping. This makes the passcode authentication system low cost and allows for a small form factor design since neither keypad nor screen/numeric display devices are required.

### CROSS REFERENCE TO RELATED APPLICATIONS

None

### STATEMENT OF FEDERALLY SPONSORED RESEARCH OR DEVELOPMENT

N/A

### NAMES OF THE PARTIES TO A JOINT RESEARCH AGREEMENT

None

### FIELD OF INVENTION

This invention is directed to electronic devices with embedded authentication systems.

### BACKGROUND OF INVENTION

Passcode authentication has become a daily activity in modern information technology era. The need for passcode authentication has been expanded from computers and doorlock security systems to smaller wearable devices such as smart watches. Furthermore, passcode authentication is an important fall-back option in the broad biometric systems. In many recent smaller sized applications, it is difficult to have proper user interfaces for passcode fall-back option because of the size or cost limitations. Accordingly, a low cost and small form factor passcode authentication system is desired in many modern biometric as well as non-biometric authentication devices.

### SUMMARY OF THE INVENTION

The invention provides methods and systems for passcode authentication system in a small form factor at low cost. Current standard scheme of alpha numeric interfaces for the passcode is replaced by color displays, wherein the code selection is done by colors and interfaced through the color displays using light emitting diodes (LED) instead of alphanumeric displays. For example, the code entry is done by a sequence of color selections. This approach reduces the spaces required for the code entry and display by eliminating the needs for keypad and alphanumeric display. As a result, a smaller form factor design is possible and reduces the overall system cost.

### BRIEF DESCRIPTION OF THE DRAWINGS

FIG. 1 is a block diagram of a passcode authentication system according to an embodiment of the invention.

FIG. 2 is a detailed block diagram of an embodiment of the invention.

FIG. 3 is a block diagram of a prior art passcode authentication system.

FIG. 4 is an example of simple user interface according to an embodiment of the invention.

FIG. 5 is a flow chart of the top level MCU software flow.

FIG. 6 is a flow chart of the passcode registration method using a single color select button according to an embodiment of the invention.

FIG. 7 is a flow chart of the passcode verification method using a single color select button according to an embodiment of the invention.

FIG. 8 is a flow chart of the passcode registration method using color-mapped multiple color select key according to an embodiment of the invention.

FIG. 9 is a flow chart of the passcode verification method using color-mapped multiple color select key according to an embodiment of the invention.

FIG. 10 is a table showing an example of color codes for 7 colors according to an embodiment of the invention

FIG. 11 shows an example of color transitions as the single color selection button is pressed causing the counter value CNT to increase by one according to an embodiment of the invention.

### DETAILED DESCRIPTION OF THE EMBODIMENTS

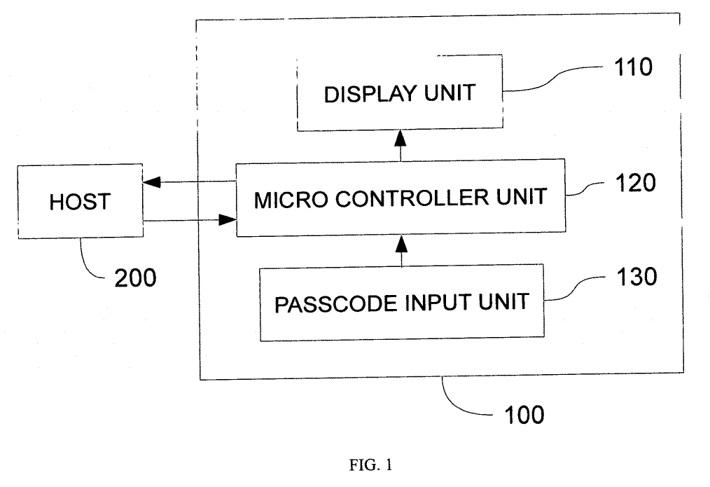

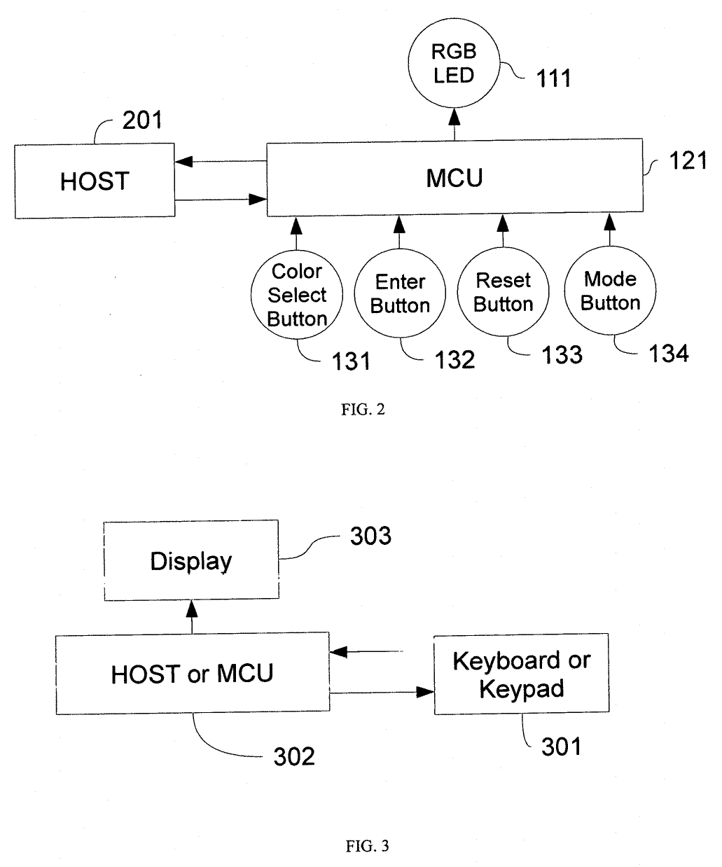

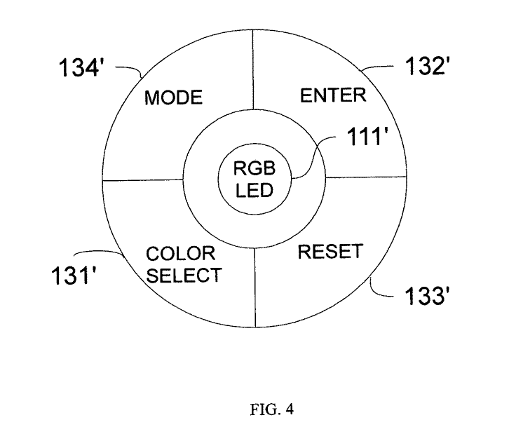

FIG. 1 is a block diagram of an authentication system according to an embodiment of the invention. As shown in FIG. 1, an authentication system 100 according to the present embodiment of the invention includes a display unit 110, passcode input unit 130 and a micro controller unit 120, which may or may not connected to a host 200, depending on the complexity of the application system. FIG. 2 shows a more detailed block diagram of an embodiment of the invention. FIG. 3 shows a prior art system where display device 303 is typically computer screen or alphanumeric display units. The input device 301 is usually keyboard or keypad with an array of switches, which makes it impractical to implement in a small form factor. FIG. 4 shows an embodiment according to the invention where display device 111′ is a very simple RGB LED which is capable of illuminating distinct colors as many as the number of color codes used in the device. Four buttons 131˜134 in FIG. 3 are arranged in a circular form shown as devices 131′˜134′ in FIG. 4. The smaller number of buttons and absence of large display screen or alphanumeric display makes it possible to have a smaller form factor and low cost.

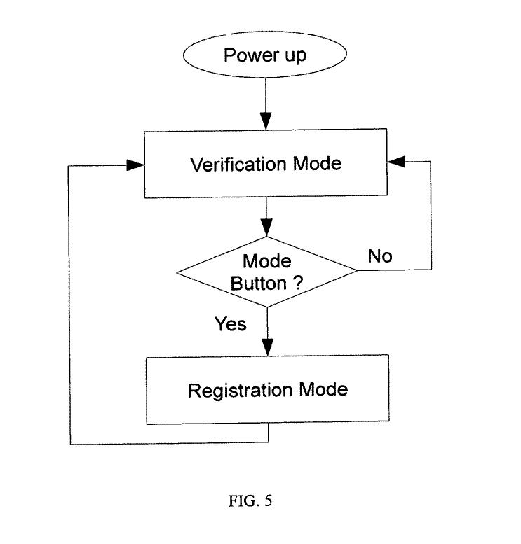

FIG. 5 shows the top level software flow in the MCU where Verification Mode and Registration Mode are selectable by a Mode button 134. A passcode authentication system first need to be set up for a passcode in a Registration Mode. A mode select switch 134′ in FIG. 4 is used to select the Registration Mode.

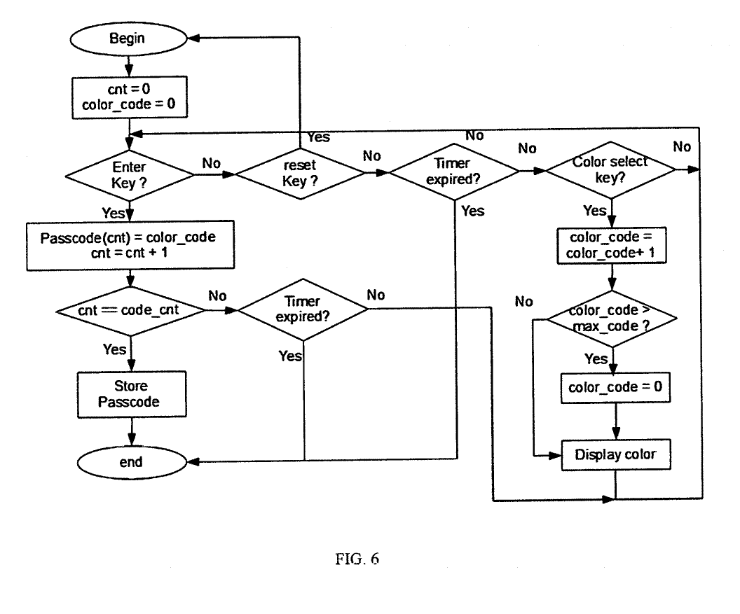

FIG. 6 shows flow chart for registration using a single color select button.

First a user selects a desired color using the button 131′ in FIG. 4, and then press the enter button 132′. This process is repeated as many times as defined by the length of the passcode, for example, 5 in a preferred implementation. At the end of the registration, a sequence of 5 colors are stored as a sequence of 5 color codes in the memory as a ‘Passcode’, where the color code is assigned as a counter value. Once registration is completed, the mode is returned to Verification Mode as shown in FIG. 5. One can restart the registration process by pressing reset button 133′ if desired so. If the registration process is stopped in the middle or takes too long, a timer measures the time laps and if the time laps is bigger than a predefined value, it terminates the registration process.

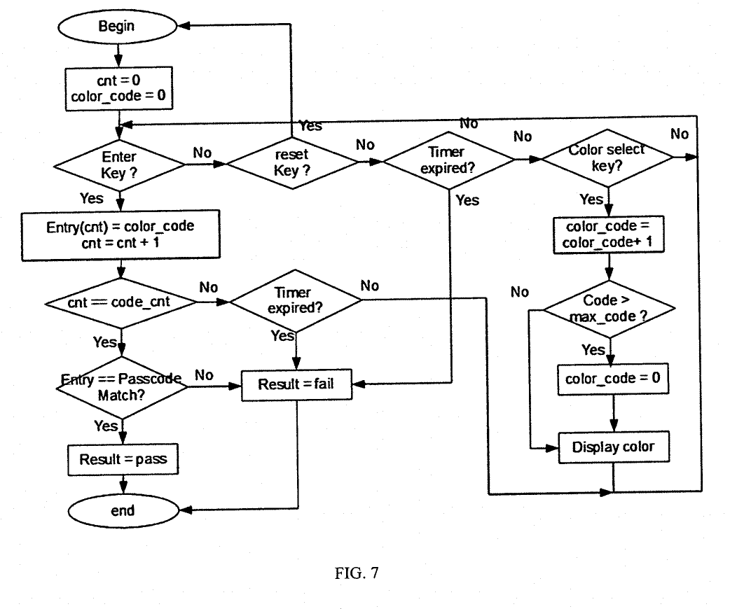

FIG. 7 shows the flow chart for registration using color-mapped multiple color select key. In this case, each button is mapped to a color and a color code. No counter is used to select the desired color, but color mapped buttons are mapped to respective colors and color codes. Similarly as in FIG. 6, a sequence of color codes, for example, 5 color codes, is stored in the memory as a passcode. The difference between FIG. 6 and FIG. 7 is the number of buttons used for color selections and the method by which color code is assigned.

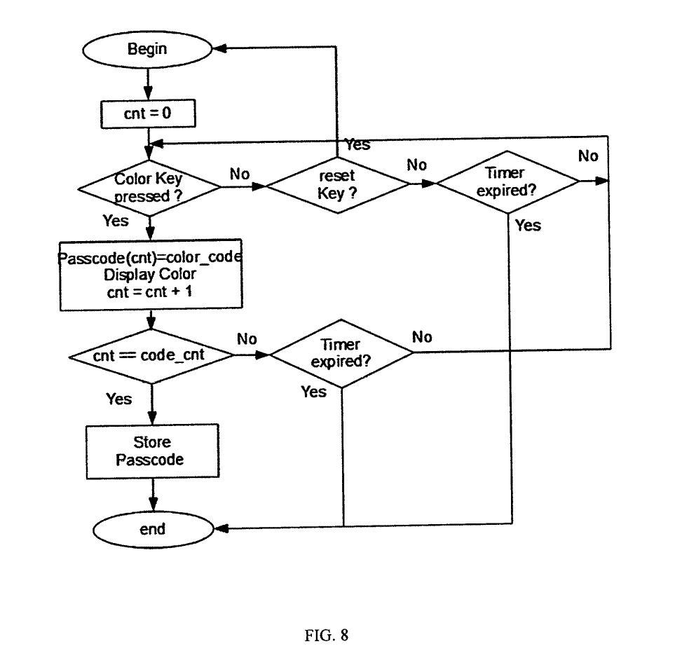

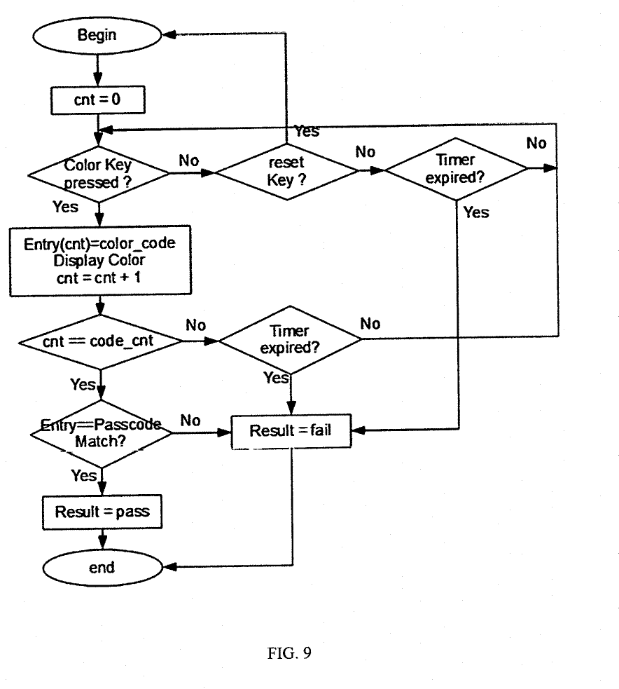

Once a passcode is set up, the device returns to the normal mode or Verification Mode. In the Verification mode, a user selects a sequence of colors as similarly done during the Registration Mode. FIG. 8 shows Verification Mode flow chart with a single color select button, and FIG. 9 shows Verification Mode flow chart with a set of color-mapped color select keys.

Again, as before, the difference is the number of buttons used for color selections and the method by which color code are assigned.

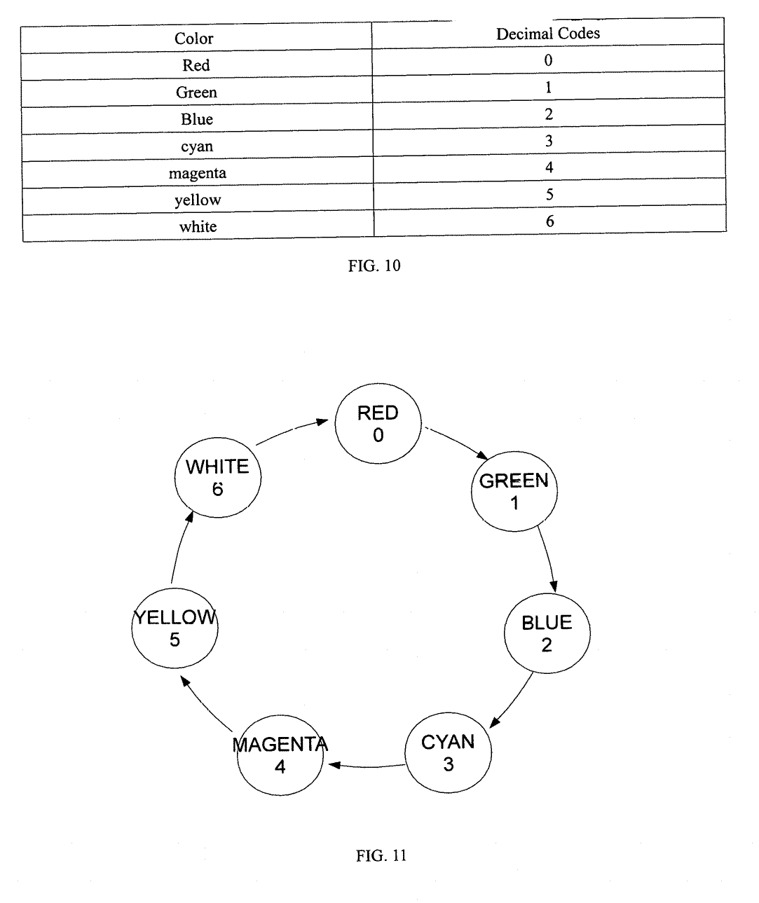

FIG. 10 shows an example of a color set and matching color codes such that as the software counter value (cnt) increases, the selected color make transitions as shown in FIG. 11.

When the whole sequence of colors (color codes) typed in by a user matches with the color code sequence stored in the micro controller (MCU), a ‘PASS’ signal is sent to the host, or unlock signal is generated. In the case of mismatch, ‘FAIL’ signal is generated or no unlock signal is generated (or lock signal is generated). As is well known to a person in the art, the passcode setting is possible only in the unlocked state.

What is claimed is:

1. A passcode authentication system comprised of:
color display device;
color selection device;
micro controller and non-volatile memory for storage of a single or plurality of passcodes;

2. The passcode authentication system of claim 1, wherein color display comprised of a single RGB-LED and/or combination of single color LEDs.

3. The passcode authentication system of claim 1, wherein color selection device comprised of a button and a counter implemented in software in the micro controller.

4. The passcode authentication system of claim 1, wherein color selection device comprised of plurality of buttons where each button is mapped to respective unique color.

5. A passcode authentication method comprised of:
selecting and displaying a selected color using LED or other means of displaying colors;
mapping unique codes respectively to each of all the colors used;
saving sequence of color codes that corresponds to the sequence of colors a user selected;
comparing the sequence of codes stored in the non-volatile memory with the sequence of codes generated by a sequence of colors a user selected;
generating ‘PASS’ or ‘FAIL’ signal based on the match result.

6. The passcode authentication method of claim 5, wherein selecting the current color comprised of using a software counter and a pulse generator using a button.

7. The passcode authentication method of claim 5, wherein generating a sequence of color codes from the counter values.

8. The passcode authentication method of claim 5, wherein selecting current color comprised of using plurality of buttons, wherein each button is one-to-one mapped to the colors.

9. The passcode authentication method of claim 5, wherein generating a sequence of color codes from the sequence of buttons selected.
